(19) United States
(12) Patent Application Publication
(10) Pub. No.: US 2008/0092113 A1
(43) Pub. Date: Apr. 17, 2008

(54) SYSTEM AND METHOD FOR CONFIGURING A PROGRAMMABLE ELECTRONIC DEVICE TO INCLUDE AN EXECUTION ENGINE

(76) Inventors: Randall K. Weinstein, Atlanta, GA (US); Christopher T. Church, Palm Bay, FL (US); Robert H. Lee, Roswell, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/870,945

(22) Filed: Oct. 11, 2007

Related U.S. Application Data
(60) Provisional application No. 60/851,192, filed on Oct. 12, 2006.

(51) Int. Cl. G06F 9/44; G06F 9/45

(52) U.S. Cl. 717/106; 717/156

(57) ABSTRACT

An electronic device configuration that models a dynamical system can be produced by compiling program code written in a specialized modeling language into directed flow graph data, and then transforming the directed flow graph data into device configuration data. The device configuration data represents an electronic device configuration that includes an execution engine modeling the dynamical system.

### CROSS-REFERENCE TO RELATED APPLICATION

The benefit of the filing date of U.S. Provisional Patent Application Ser. No. 60/851,192, filed Oct. 12, 2006, is hereby claimed, and the specification thereof is incorporated herein in its entirety by this reference.

### BACKGROUND OF THE INVENTION

1. Field of the Invention

The present invention relates generally to modeling of real-world systems using execution engines and, more specifically, to systems and methods for programming or configuring an electronic system or device to include such an execution engine.

2. Description of the Related Art

Scientists and engineers often use computers to model certain types of real-world systems (often referred to as dynamical systems) that they wish to study or otherwise work with. Some of these dynamical systems are extremely complex and are best modeled using clustered computing platforms with distributed computing software tools that allow the modeler to utilize the power of perhaps hundreds or thousands of core processing units or other logic resources embodied in hardware or software. For example, there is great interest among researchers in modeling the neural structure of the brain. The field-programmable gate array (FPGA) has been shown to be capable of providing a powerful processing platform that is useful for embodying generic neural models. An FPGA programmed to implement or embody such a neural model represents a type of execution engine. An FPGA-based neural model is merely one example of an execution engine; researchers and others involved in other fields of endeavor use other types of execution engines to model dynamical systems in those fields. A common thread among dynamical system models used in many disciplines is that they can be mathematically described as systems of differential equations (or difference equations).

As neuroscience is primarily a biological science, few researchers are skilled at the digital system design process that is needed to program or configure an FPGA to function as a neurological-model execution engine. Digital system design requires skill with digital logic, synchronous timing among digital logic elements, fixed-point number systems, and other concepts that are somewhat alien to researchers in biological and similar sciences. Such researchers commonly think of their models in terms of systems of differential equations and have difficulty translating that knowledge into an efficient implementation of those equations in an FPGA-based execution engine. Engineering tools have been developed to facilitate FPGA and application-specific integrated circuit (ASIC) design, but none truly isolates the modeler from the intricacies of digital system design. Most commercially available tools enable the designer to describe the FPGA or ASIC logic by writing software code using the now-standard Very High Speed Integrated Circuit (VHSIC) Hardware Description Language (VHDL) or the Verilog hardware description language and then compiling the software code into a netlist file that can be used to directly program the FPGA or ASIC device. However, these languages still require knowledge of digital logic and of the architectures of the various resources available in the device. Translation tools that translate software code written in general-purpose higher-level languages such as C into VHDL or Verilog code have been developed. Using such a translation tool would allow a researcher to describe a dynamical system model using the high-level mathematical constructs (e.g., differential equations) with which the researcher is comfortable and familiar. However, such translators are inefficient at generating FPGA logic that implements dynamical system models, potentially wasting FPGA resources. Inefficiency arises from several areas, including the translation tool's need to cope with C-language constructs such as pointers, linear memory mappings, and unbounded loops, which are germane to computer programming but not to programming or configuring a programmable device such as an FPGA to implement a dynamical system model.

### SUMMARY OF THE INVENTION

The present invention relates to a computer-implemented method, system, and computer program product for producing an electronic device configuration that models a dynamical system. In an exemplary embodiment of the invention, the dynamical system model is first described using a novel iterative modeling programming language in which a state of the dynamical system model on each iteration is encoded in a state primitive of the modeling language. The resulting program code (data file) is then compiled using a corresponding compiler for the modeling programming language. The compiler produces directed flow graph data representing the dynamical system. The states of the dynamical system define roots of directed flow graphs. Then, a system generator transforms the directed flow graph data into device configuration data. The device configuration data represents an electronic device configuration that includes an execution engine modeling the dynamical system.

In accordance with the exemplary embodiment of the invention, the configuration data can then be used to program or otherwise configure a suitable electronic device, such as a field-programmable gate array (FPGA). An FPGA is merely intended to be an example of such a device, and in other embodiments of the invention the configuration data can be used to configure any other suitable device, such as a cluster of general-purpose processors.

The following Detailed Description illustrates the invention more fully, through one or more exemplary or illustrative embodiments of the invention.

### BRIEF DESCRIPTION OF THE DRAWINGS

FIG. 1 is a block diagram of a computer system programmed to produce an electronic device configuration that models a dynamical system, in accordance with an exemplary embodiment of the invention.

FIG. 2 is a high-level flow diagram of a method for producing an electronic device configuration that models a dynamical system, in accordance with the exemplary embodiment of the invention.

FIG. 3 illustrates a program code file for modeling an exemplary dynamical system.

FIG. 4 is a flow diagram illustrating in further detail the compiling step shown in FIG. 2.

FIG. 5 illustrates an exemplary directed flow graph.

FIG. 6 is a flow diagram illustrating in further detail the transforming step shown in FIG. 2.

FIG. 7 is a flow diagram illustrating in further detail the scheduling step shown in FIG. 6.

FIG. 8 illustrates an exemplary dynamic resource table of the system of FIG. 1.

FIG. 9 is a block diagram of a system for facilitating the use of the programmed electronic device of FIG. 1.

### DETAILED DESCRIPTION OF AN EXEMPLARY EMBODIMENT

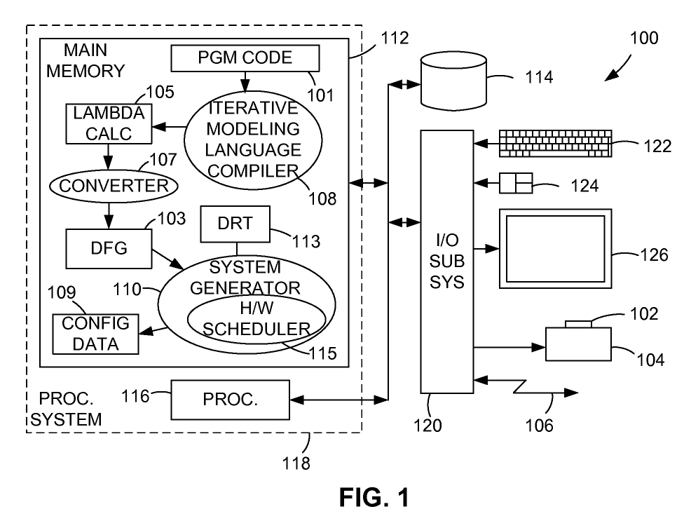

As illustrated in FIG. 1, in an exemplary embodiment of the invention a programmed computer system 100 allows a user to configure an electronic device 102, such as a field-programmable gate array (FPGA), through a device programmer 104. Computer system 100 can include a conventional personal computer, either standing alone or operating in conjunction with other (e.g., server) computers (not shown) via a network connection 106 or other suitable interconnection. That is, although a single computer system 100 is shown for purposes of illustration, the terms “computer” and “computer system” as used in this patent specification (“herein”) are intended to include within their scope of meaning any other suitable number and combination of computers, computer peripherals, processing devices and other suitable hardware and software elements, distributed or otherwise arranged in any other suitable manner.

The software elements of such a system include a specialized compiler 108 and a system generator 110, which are conceptually shown for purposes of illustration as residing in a main memory 112 of computer system 100. Persons skilled in the art to which the invention relates understand that, in accordance with well-understood computing principles, such software elements do not necessarily actually reside simultaneously or in their entireties in such a memory 112 but rather are retrieved from a data storage device 114 (e.g., a hard disk drive) or from a remote source (e.g., via network connection 106) in modules or chunks on an as-needed basis under control of the processor 116. Processor 116 can include one or more processing elements (not separately shown), such as one or more microprocessor chips and other associated elements. Processor 116 and memory 112, in combination with each other and with any other associated hardware and software elements (not shown for purposes of clarity) commonly included for purposes of providing the processing or computing power in such a computer system can be considered for reference purposes to constitute an overall processing system 118. As the programmed computer system 100 shown in FIG. 1 is intended merely to represent one example or embodiment of the invention, it should be noted that in other embodiments the system generator portion can differ in structure and function from what is shown in FIG. 1. For example, an alternative system generator can comprise elements for programming a cluster of general-purpose core processors. However, in view of the descriptions herein, persons skilled in the art to which the invention relates will understand how other such embodiments can be made and used. Also, it should be noted that the combination of software elements along the lines of those discussed above and the memory 112 or other computer-readable media, constitutes a “computer program product” as that term is used in the context of computer-implemented inventions.

In addition to compiler 108 and system generator 110, processing system 118 is programmed with other software elements of the types typically included in such a computer system, such as an operating system, but such other software elements are not shown for purposes of clarity. An input/output subsystem 120 interfaces processing system 118 with the various conventional user input and output devices and other inputs and outputs of such a computer system, such as a keyboard 122, mouse 124, display screen 126, and network connection 106. Input/output subsystem 120 is depicted as a unitary element in FIG. 1 for purposes of clarity, but can include any suitable number and type of hardware and software elements arranged in any suitable manner known in the art. Input/output subsystem 120 further interfaces processing system 118 with device programmer 104.

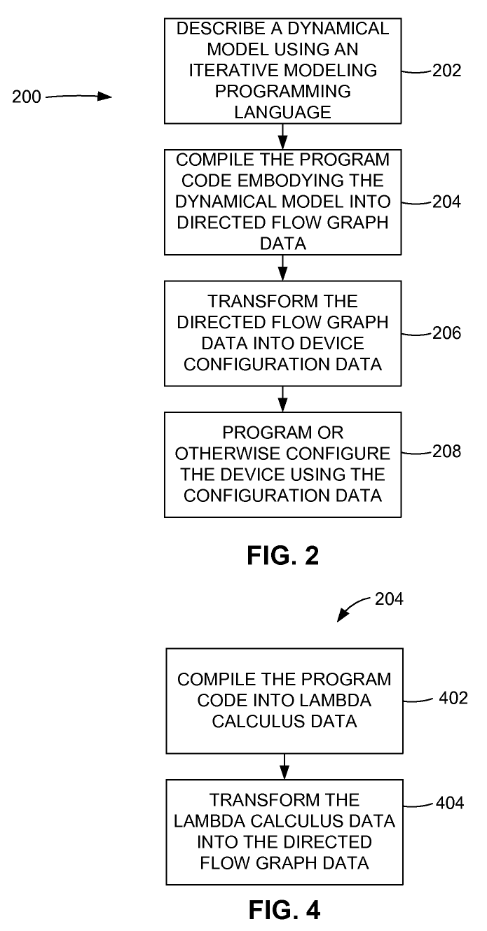

An exemplary method 200 for producing an electronic device configuration that models a dynamical system is illustrated in FIG. 2. At step 202, a user describes a dynamical system model using a specialized iterative programming language. The programming language has a syntax with features that are specially adapted for modeling a dynamical system as a system of one or more difference equations. Unlike a general purpose language such as C, Java, etc., code is not executed sequentially on a line-by-line basis but rather is executed in a manner more similar to that in which a hardware description language, such as VHDL or Verilog, are executed, where each line is evaluated in parallel. Where a model is described in the programming language by two or more difference equations, the equations will be solved simultaneously when the code is compiled and executed. A feature of the language is that program flow is implicitly defined to occur within a loop (i.e., there is no loop code structure for the programmer to explicitly write), mimicking the conventional iterative approach to numerically solving differential equations. As used herein, the term “difference equation” also includes differential equations within its scope of meaning.

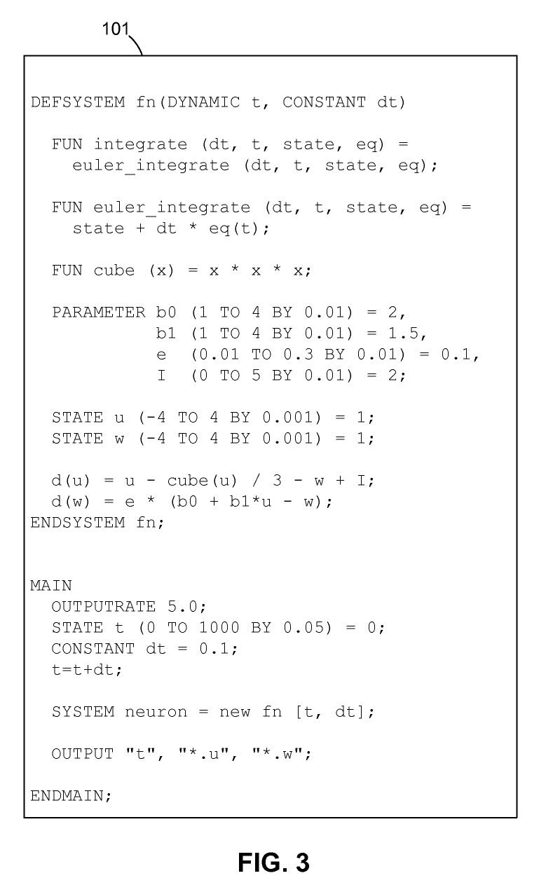

In addition to the following general description of the structure and use of an exemplary embodiment of this programming language and its corresponding compiler 108 (FIG. 1), Extended Backus-Naur Form (EBNF) notation describing its grammar is included below as an Appendix to this patent specification. The user can write program code 101 (FIG. 1) in this language that represents or encodes a dynamical system model. One syntax feature is a STATE primitive or data-type. When the (compiled, loaded, etc.) program code is executed (i.e., runtime), on each iteration the STATE primitives that the user has defined are set to the values or states of the dynamical system model. A STATE primitive in its general form represents a first-order difference equation. Higher-order difference equations can readily be decomposed into a set of first-order difference equations. A state primitive supports both linear and non-linear and both homogeneous and inhomogeneous equations. Another syntax feature is a differential equation primitive or statement that allows the user (programmer) to express a differential equation as a single statement. A differential equation, when numerically solved, is a special case of a difference equation. A straightforward example of how a dynamical system represented by the pair of differential equations shown below can be encoded in this language is shown in FIG. 3.

$$\frac{d u}{d t} = u - \frac{{u}^{3}}{3} - w + I$$

$$\frac{d w}{d t} = ɛ \times ( {b}_{0} + {b}_{1} \times u - w )$$

The dynamical system model is defined by code enclosed within a MAIN . . . ENDMAIN block. This is akin to the Java “main” method and is considered the top level of the model. Within the main block, equations can be defined, but the main block is primarily intended for instantiating “systems” (i.e., the basic descriptions of the dynamical systems to be modeled). Systems can be defined hierarchically. A system is defined by code enclosed within a DEFSYSTEM . . . ENDSYSTEM block. Systems can define equations or additional sub-systems.

A system is instantiated in a main block or another system via the new function. An example could be:

SYSTEM mySystem=new SysDef(x,y,z);

where mySystem will be the instantiated system name, SysDef is the name of the system definition, and x, y, and z, are all parameters of SysDef. Quantities can be referenced outside the system as mySystem.varname, where varname is replaced with the actual variable name. Within a system or a main block, the user can define states with the syntax:

STATE var(low TO high BY step)=var₀;

The user can similarly define parameters with the syntax:

PARAMETER var(low TO high BY step)=var₀;

States and parameters each need initial values (indicated by the subscript 0 syntax) and a range consisting of a maximum value, a minimum value, and a step value indicating the required precision of a value. For example, in a scenario in which the user is modeling a neural system, a neuron membrane voltage potential, Vₘₑₘ, might have a voltage range from −90 mV to 60 mV. The user (modeler) might decide that 10 μV is the smallest step size that is relevant. An initial value for a membrane potential could be, for ex ample, the neuron's resting membrane potential, typically around −60 mV. An exemplary state definition could be:

STATE Vmem(−90 TO 60 BY 0.01)=−60;

Parameters, along with inputs which require a range, and constants which do not require range information, make up the inputs to the system. Compiling the code propagates the range information through the graphs described below, from the leaves (the current states, parameters, inputs, constants, and literals) to the root (the writing of the next state). These precisions are then used to determine the appropriate fixed-point precision.

The language provides three means for defining equations, or expressions that are evaluated on each iteration. First, an intermediate equation consists of an intermediate variable, which is implicitly defined in the system by assigning a variable name to an expression. The assignment operator is an equals (“=”) sign. The left-hand side of the equation is the variable name, and the right-hand side is the expression. An example equation could be

INa=gNa*(Vm−ENa);

In this example, the variable INa is an intermediate variable, meaning the name is defined in the system, but it is not a state, and therefore the compiler could perform an optimization that removes the name if not needed. The variable INa is implicitly defined, since no additional declaration of INa is required for INa to be classified as an intermediate variable. Consider the example equation:

x=1+2;

### In this equation, x can be readily replaced by 3 if x is not an output of the system.

The second type of equation is that which defines a state. These equations update the values of states and provide memory storage for those states to be used in the next iteration. For example, time can be defined as a state equation. The time at the current iteration, t[n], can be defined to be equal to the previous time, t[n−1], plus a time step, dt. In the language, this would appear as t=t+dt;. Here, the ton the left-hand side of the equation is implicitly the current value of time while ton the right-hand side is implicitly the previous value of time. One skilled in the art can readily see how multiple statements like the above example can describe any difference equation.

The third type of equation is the differential equation. This syntax is used to define first-order differential equations. An example, the growth of bacteria in a dish could be modeled by an exponential growth function of the form,

$$\frac{d x}{d t} = k x$$

where x is the population size and k is a growth coefficient. In the language, the differential equation form would look like d(x)=k*x;. The d(x) term implicitly utilizes t as the differentiation variable.

The user can define functions with the FUN statement using the syntax:

FUN name(args)=expression;

For example, a cube function can be defined by FUN cube (x)=x*x*x;. The parameters of the function are comma delimited after the function name and have local scope within the function only. An integrate function is a reserved-name function that must be present when utilizing the d(x) syntax. This function defines the integration algorithm to utilizes when numerically solving the equation. For example, forward-Euler integration can be defined using the following function:

FUN integrate(dt,t,state,eq)=state+dt*eq(t);

In this exemplary embodiment, there are two processes by which data is sent to the model and one process for data to be received from the model. Data can be sent to the model via parameters and inputs. Parameters are optimized for large numbers of quantities with high precision that are updated infrequently. Inputs are optimized for fewer quantities that are updated at a regular time interval, for example, 10,000 times per simulation second. Parameters can be defined anywhere in a system or main block. Inputs are defined with the INPUT keyword and a range and can exist only in a main block.

Data is received from the model by way of outputs. Outputs are streaming quantities that are produced every cycle or fixed multiple of cycles. Outputs can be declared using the OUTPUT keyword and the variable names following in a comma-delimited list. Wildcards, such as “neuron*.Vm”, are supported to match all quantities with the name “Vm” in any system instantiated with a name beginning with “neuron”. A global output sample rate is defined using the reserved keyword OUTPUTRATE in a main block.

The language provides two types of conditional statements. First, there is an IF function which returns a true expression when the condition is true and a false expression when the condition is false. For example, a neural membrane voltage potential, Vₘₑₘ, can be defined to be equal to a command voltage, V_{cmd}, when the voltage is to be fixed and should vary according to a different voltage, Vₓ, when the membrane potential is evolving over time. An exemplary expression could be:

Vmem=IF voltage_fixed THEN Vcmd ELSE Vx;

Since the IF syntax behaves as a function but resembles a statement, another syntax is provided that mimics how a piece-wise function would be written. Using this other syntax, this same equation could be written as:

Vmem={Vcmd WHEN voltage_fixed,Vx OTHERWISE};

The language includes features for handling scalar quantities and list quantities. As with other functional languages, the concatenate operator, “::”, returns a new list from a scalar and an input list. A scalar can be converted to a list by enclosing the quantity in a brackets (“[”,“]”). A null list is defined to be NIL. By including this list functionality, object identification functions (isList( ), etc.), and the ability to define new functions, one skilled in the art can readily see how common functional programming constructs such as head, tail, map, foldl, foldr, etc. can readily be generated. The use of these functions enables the language to take on a model construction role along with a model definition role. In view of the above and included EBNF Appendix, persons skilled in the art will readily be capable of writing program code 101 (FIG. 1) in this language to model a dynamical system and providing a suitable compiler 108 for the language.

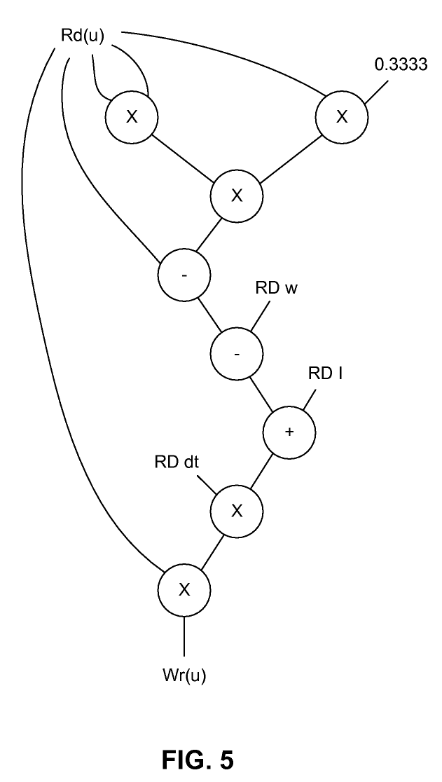

At step 204, the user inputs the program code 101 that was created at step 202 (in the form of a data file) to compiler 108 (FIG. 1). As described below in further detail, compiler 108 compiles program code 101 into directed flow graph data 103 (FIG. 1) defining one or more directed flow graphs, an exemplary one of which is shown in FIG. 5. Note that the states of the dynamical system (as represented by the quantities defined as having a STATE data-type) define the roots of the exemplary directed flow graph. Each state variable in the system is converted to one graph.

As shown in FIG. 4, step 204 can be performed in multiple steps, by first performing the step 402 of compiling program code 101 into an intermediate representation, such as a lambda calculus 105 (FIG. 1), and then performing the step 404 of transforming or converting the intermediate representation into a directed flow graph. As part of step 402, compiler 108 performs lexical analysis and parsing upon code 101 (FIG. 1) in accordance with the EBNF grammar set forth in the Appendix. The parsing produces an abstract syntax tree (AST), a data structure representing the program code. As well understood in the art, an AST is a finite, labeled, directed tree, where the internal nodes are labeled by operators, and the leaf nodes represent the operands. For example, an AST representation for the differential equation d(x)=y−b would be

EQUATION(DIFFERENTIAL,x,BINARYOP(SUBTRACT,[SYMBOL y,SYMBOL b]))

### Compiler 108 then performs a semantic analysis on the AST, whereby it can identify and report errors, such as an undefined variable in an expression.

As shown in FIG. 1, a conversion element 107, which is shown as a separate element for purposes of clarity but which can alternatively be part of compiler 108 or other elements of the system, can perform step 404. Although lambda calculus is the intermediate representation in the exemplary embodiment of the invention, in other embodiments having an intermediate representation it can comprise an expression tree, a so-called “basic block,” a Turing machine, stack-based machine, register machine, SKI combinatory calculus, or any other suitable intermediate representation that will occur readily to persons skilled in the art in view of the teachings herein. As well understood in the art, the following is an example of a lambda calculus corresponding to the differential equations above:

λx.λy.λz.x+dt*(x−x*x*x/3−y+z)

λv.λw.λx.λy.λz.y+dt*v*(w+x*y−z)

The lambda calculus computations are composed of the following constructs: a mapping of parameter names and parameter values, a mapping of state names and state initial values, a mapping of the previous state values to the current state values (which returns a function), a mapping of state names to range values (low, high, step), and a listing of system inputs, outputs, and a sample rate if defined.

The lambda calculus is evaluated to produce a series of expression trees, or an expression tree forest. A method along the lines of head normal form conversion can be used. If this conversion fails, a basic assumption of the language has been violated. For example, an internal loop in the system must be unrolled to a fixed number of steps. Another example of a failing condition is that two intermediate variables are defined as functions of themselves producing an algebraic loop.

Referring again to FIG. 2, at step 206 the directed flow graph data 103 is input to system generator 100 (FIG. 1). System generator 100 transforms the directed flow graph data into device configuration data 109. As indicated by step 208, device configuration data 109 can be used to program a device 102, such as an FPGA, either directly or by transforming it still further. For example, it could be transformed into a conventional hardware description language, such as VHDL or Verilog, which would then be compiled into another form of device configuration data using a conventional VHDL or Verilog compiler. In any case, device 102 can be programmed by downloading that device configuration data to device programmer 104. As noted above, in other embodiments of the invention, the device can be programmed or otherwise configured in any other suitable manner. For example, in such an embodiment an element similar to device programmer 104 can program a non-volatile memory device (EPROM, EEPROM, FLASH, ETC.) (not shown) that, following programming, is coupled with device 102 on a circuit board (not shown) in a manner that allows device 102 to retrieve its programming from the memory device at runtime, i.e., at the time the model is to be executed or run. Alternatively, some circuit board or other system (not shown) in which device 102 is constituent element can be programmed in accordance with the Joint Test Action Group (JTAG) protocol (IEEE standard 1149.1). In such an embodiment, a JTAG programmer device (not shown) that interfaces with computer system 100 and the circuit board loads the JTAG data onto any device in the JTAG chain. In still other embodiments, computer system 100 can transmit commands to another processor (not shown) that emulates JTAG (or similar protocol) data, to which the processor responds by programming or configuring the device.

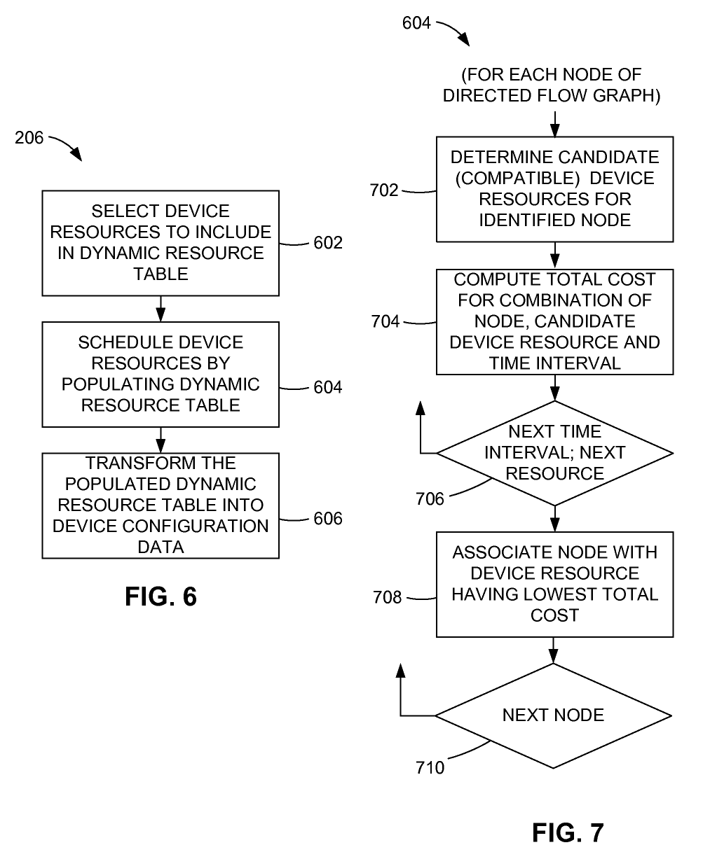

Step 206 is illustrated in further detail in FIG. 6 and involves the use of a data structure referred to herein as a dynamic resource table 113 (FIG. 1). At step 602, the user selects resources of device 102 to include in dynamic resource table 113. Step 602 is only useful in an embodiment of the invention in which the device to be configured is of a type that has selectable resources. An FPGA is an example of such a device having selectable resources, because the resources consist of low level primitives (e.g., lookup tables, registers, and in some cases, fixed-size multipliers), which can be combined and configured by a synthesis tool to form adders, subtracters, multiplexers and other primitive or low-level logic elements that a user can choose to define in different ways. For example, a user can select more adders to include at the expense of having to limit the number of other types of resources to include. Similarly, a user can select adders that offer higher precision arithmetic at the expense of space on the FPGA, since higher-precision adders take up a substantial amount of space. As persons skilled in the art understand the manner in which an FPGA designer conventionally must select resources and the ramifications of such selections, this step is not described herein in further detail.

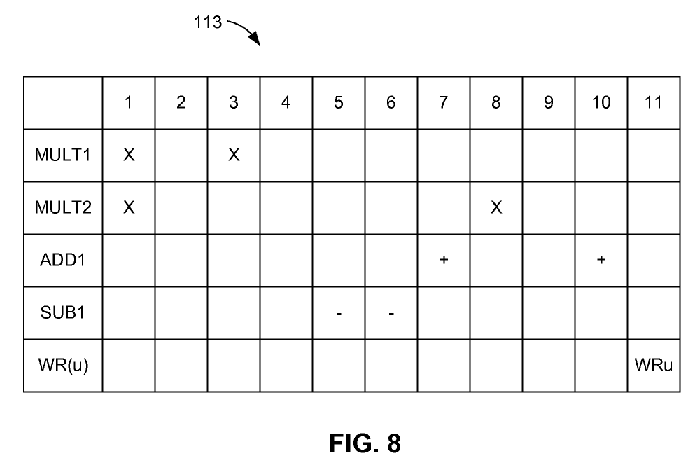

An example of dynamic resource table 113 is shown in FIG. 8. Note that the resources selected at step 602 (e.g., two multipliers, an adder, a subtracter, etc.) represent the rows of table113, and time intervals represent the columns. (The item labeled “Wr(u)” represents the act of writing or storing the result or state “u” into a memory location of a register, which is one of the selected resources.) Resources are considered to be fully pipelined, i.e., having a sample period of one time step, for this example. In other embodiments, resources may not be fully pipelined, and instead utilize internal feedback that reduces the total number of operations that can be assigned to a particular resource. At step 604, system generator 110 schedules the selected resources by populating dynamic resource table 113 with the selected resources. As described below in further detail, step 604 entails traversing the directed flow graph (e.g., FIG. 5) or otherwise processing each node in it and associating each node with one of the selected resources and at least one of the time intervals in dynamic resource table 113. Note in FIG. 8 that table 113 has been populated in an illustrative manner with resources comprising multipliers, adders and subtractors, represented by the “X”, “+” and “−” symbols, respectively. Each resource symbol in table 113 indicates that device 102 (e.g., an FPGA) is to be configured to use the resource indicated by the row in which the symbol appears during the time interval indicated by the column in which the symbol appears. Eleven time intervals are shown for purposes of illustration. The same symbols are used to represent the corresponding operations in the exemplary directed flow graph shown in FIG. 5. Finally, at step 606, system generator 110 transforms the populated dynamic resource table 113 into device configuration data 109 (FIG. 1), as described below in further detail.

Step 604 of scheduling device resources using dynamic resource table 113 is illustrated in further detail in FIG. 7. A hardware resource scheduler module 115 of system generator 110 (FIG. 1) can perform this step. The step involves evaluating, for each node in the directed flow graph, all combinations of selected resources and time intervals. (Nested loops or other such program flow structures that can be used to arrive at all such combinations are not shown for purposes of clarity.) For each node evaluated, all resources (of those that have been selected) that are compatible with that node are identified or determined, as indicated by step 702. A straightforward example is identifying all selected adders on an FPGA as compatible with a node representing an addition operation. The identified resources become candidates that, using the following multi-metric cost analysis, can be selected for inclusion in table 113.

At step 704, a cost is computed for the combination of node, resource, and time interval being evaluated. The cost analysis is described in further detail below, but it can use metrics that are based upon various relevant criteria, including but not limited to: (1) whether a resource has already been associated with another node and time interval; (2) the ratio of resources that have already been associated with other nodes and time intervals to resources that have not yet been associated with other nodes and time intervals; (3) the results of comparisons of topologies between directed flow graphs; (4) bit-widths of compatible resources; (5) decimal point alignment; (6) latency; (7) successor nodes to the node being evaluated; and (8) predecessor nodes to the node being evaluated. Steps 706 and 710 represent the above-mentioned nested looping or equivalent program flow structure that enables evaluation of each combination of node, selected resources and time intervals. When all combinations of resource and time interval have been evaluated for a node, then at step 708 the resource having the lowest cost (as represented by a numerical value) is selected and associated with the node by placing it in the corresponding row/column position in the table.

With further regard to the exemplary metrics enumerated above, the first-listed metric (1) of whether a resource has already been associated with another node and time interval can be used to discourage the selection of a resource that has not already been assigned an operation. For example, if there are 100 operations and only 10 resources, it might not be efficient if the first 10 operations were each assigned to a unique resource, since one of the remaining 90 operations might be vastly different, resulting in a non-optimal implementation (for example, a very low precision operation might get assigned to a resource with a high precision, resulting in wasted computation and latency. This is related to the second-listed metric (2) of the ratio of resources that have already been associated with other nodes and time intervals to resources that have not yet been associated with other nodes and time intervals. As fewer operations are left to schedule, it makes less sense to reserve resources. The weightings of these metrics balance the need to maximize the use of resources with the requirement to use them in as efficient form as possible.

The third-listed metric (3) above refers to a step in which a correlation table (not shown) can be produced in which every operation is compared to every other operation. Two operations have a higher correlation if the operations are identical (for example, both additions), if the operations driving the inputs are identical on a per input basis, and if the operation on the output is identical. If two operations have the highest possible correlation, it suggests that the topology of the graph local to that operation is identical. It also suggests that there might be regular structure in the graphs and that the corresponding operations in the regular graph structures should utilize the same resource. This is a common occurrence for models consisting of populations of neurons or finite-element models. A high cost is given to those resources which are assigned operations that have little or no correlation to the current operation being evaluated.

The fourth and fifth-listed metrics (4) and (5) above of bit-widths of compatible resources and decimal point alignment, respectively, are related to the precision of the operations. If a resource, either through its initial precision, or based on the combined precision of the previously assigned operations, has a bit width greater than or equal to the current operation a total fractional precision greater than or equal to the current operation that is equal to the current operation, the resource will require no extra precision to accommodate the new operation. Otherwise, the precision of the resource will grow in either integer bits, fractional bits, or become signed when originally unsigned. The cost of these metrics is a function of the number of bits by which the resource must grow. Additionally, if the operation utilizes substantially fewer bits than the resource provides, the operation may be better suited if assigned to a different resource. This case also imparts a cost on the overall cost function. These metrics are only utilized when the resource allows for variable precisions. In architectures that are based on fixed processing cores, the precision is set to one or more fixed sizes, often single or double precision floating point.

The sixth-listed metric (6) above is related to the latency (i.e., number of cycles for execution) of the operation and the resource. Operations can not be assigned to resources that have less latency than the operation requires, unless the resource has not been previously assigned. This is because increasing the latency of a previously assigned resource can disrupt the interdependencies within the resource table. Operations with less latency can be assigned to a resource with higher latency at a cost. It is advantageous to assign an operation to a matching resource with identical latency, otherwise, extra cycles would be used for the operation that would be otherwise required, slowing down the computation.

The seventh-listed metric (7) above relates to successor nodes, or operations that are driven by the current operation. If a given resource provides an input that is used by many operations, depending on the target architecture (and specifically an issue on FPGAs), timing issue may ensue. Adding additional sinks for a signal can increase the wire length that the signal must travel and increase the capacitance that the source must overcome. The result could be too much wire delay, resulting in slower overall clock frequencies. Reducing the number of unique sinks can temper these concerns. Adding an operation with multiple sinks to a resource that already has too many sinks will be discourage by this metric.

The eighth-listed metric (8) above relates to the predecessor nodes, or the operations that are driving the inputs. If a predecessor node to the current operation is assigned to a resource that is already connected to the same input of the resource in question, then it is advantageous to assign the current operation to that resource. No additional circuitry would be required to utilize that input for that operation. Instead, if many operations were assigned to a given resource each being driven by unique resources, then the assignment of a yet another operation with a unique input resource would be disadvantageous and impart a high cost on the weighting function. Specifically, in a reconfigurable device, multiple resources driving a single input would require a multiplexer, or a device that chooses a particular input to route to the output based on control signals. These multiplexers require additional latency and resources that can otherwise be utilized for operations.

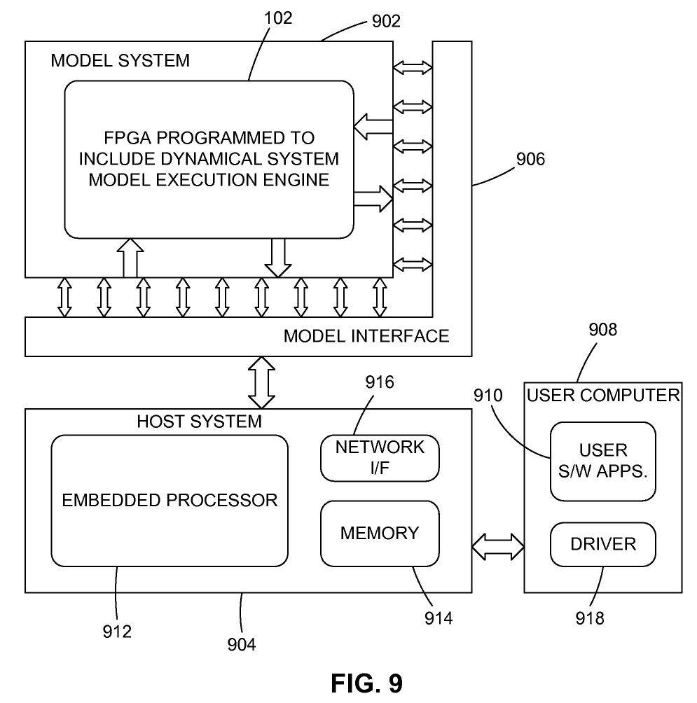

The result produced by the above-described system and method is an electronic device 102 (FIG. 1) that has been programmed or otherwise configured to include an execution engine modeling the dynamical system. In other words, device 102 can be operated, i.e., executed, in the manner of an execution engine to model the dynamical system. As illustrated in FIG. 9, for example, device 102, an FPGA, is installed in a model system 902, which is connected to a host system 904 via a model interface 906. A user can operate host system 904 from a user computer 908 that runs one or more software applications (programs) 910. Host system 904 includes an embedded processor 912, memory 914 and a network interface 916. User computer 906 interfaces with host system 904 through drivers 918. Other hardware and software elements of these systems of the type that are commonly included in such modeling systems are not shown for purposes of clarity.

Thus, for example, a user who is conducting research on the neural structure of the brain can use an FPGA that has been configured with an execution engine representing such a neural model. Using computer 906, the researcher can input data to the model, cause it to operate or execute, and observe output data generated as a result of the execution.

It is to be understood that the present invention is not limited to the specific devices, software, structures, methods, conditions, parameters, etc., described and/or shown herein, and that the terminology and notation used herein are for the purpose of describing particular embodiments of the invention by way of example only. For example, various other software elements and arrangements thereof, which can be based in other suitable programming languages, algorithms, logic, programming paradigms, etc., will occur readily to persons skilled in the art in view of the teachings herein. In addition, any methods or processes set forth herein are not intended to be limited to the sequences or arrangements of steps set forth but also encompass alternative sequences, which can include more steps or fewer steps, arranged in any suitable manner, and performed at any suitable times with respect to one another, unless expressly stated otherwise. With regard to the claims, no claim is intended to invoke the sixth paragraph of 35 U.S.C. Section 112 unless it includes the term “means for” followed by a participle.

APPENDIX
MODELING PROGRAMMING LANGUAGE EBNF

```
dynamomain ::= topleveldeflist [main]
topleveldeflist ::= {topleveldef}
topleveldef ::= ‘IMPORT’ string ‘;’
      | constdef
      | funcdef
    | systemdef
main ::= ‘MAIN’ maindeflist ‘ENDMAIN’ ‘;’
systemdef ::= ‘DEFSYSTEM’ id ‘(‘ sysarglist ’)’ deflist
‘ENDSYSTEM’ id ‘;’
sysarglist ::= {sysidlist}
sysidlist ::= sysargtype id {‘,’ sysidlist}
sysargtype ::= ‘CONSTANT’
  | ‘DYNAMIC’
  | ‘SYSTEM’
deflist ::= {def}
maindeflist ::= maindef {maindef}
maindef ::= def
    | outputratedef
    | inputdef
    | outputdef
inputdef ::= ‘INPUT’ ridlist ‘;’
ridlist ::= rid {‘,’ rid}
rid ::= id ‘(‘ lambda ‘TO’ lambda ‘BY’ lambda ’)’
outputdef ::= ‘OUTPUT’ outputlist ‘;’
outputratedef ::= OUTPUTRATE real ‘;’
outputlist ::= output {‘,’ output}
output ::= outmask
outmask ::= string
def ::= systemdef
  | funcdef
  | pardef
  | constdef
  | statedef
  | sysintdef
  | equation
funcdef ::= ‘FUN’ id ‘(‘ idlist ’)’ ‘=’ lambda ‘;’
pardef ::= ‘PARAMETER’ rasgnlist ‘;’
constdef ::= ‘CONSTANT’ asgnlist ‘;’
statedef ::= ‘STATE’ rasgnlist ‘;’
sysintdef ::= ‘SYSTEM’ asgnlist ‘;’
equation ::= ‘d’ ‘(‘ id ’)’ ‘=’ lambda ‘;’
| id ‘=’ lambda ‘;’
asgnlist ::= asgn {‘,’ asgn}
rasgnlist ::= rasgn {‘,’ rasgn}
asgn ::= id ‘=’ lambda
rasgn ::= id ‘(‘ lambda ‘TO’ lambda ‘BY’ lambda ’)’ ‘=’ lambda
lambda ::= lambdaapp
  | ‘IF’ lambda ‘THEN’ lambda ‘ELSE’ lambda
  | lambda ‘AND’ lambda
  | lambda ‘OR’ lambda
  | ‘NOT’ lambda
lambdalist ::= lambda ‘,’ lambda {‘,’ lambda}
lambdaapp ::= lambdaapp aexp
  | lambdaapp ‘(‘ lambdalist ’)’
  | aexp
  | lambdaapp ‘[[‘ lambda ’]]’
  | lambdaapp ‘.’ ‘isReady’
  | lambdaapp ‘.’ id
  | lambdaapp ‘+’ lambdaapp
  | lambdaapp ‘−’ lambdaapp
  | lambdaapp ‘*’ lambdaapp
  | lambdaapp ‘/’ lambdaapp
  | lambdaapp ‘\hat{ }’ lambdaapp
  | lambdaapp ‘%’ lambdaapp
  | lambdaapp ‘::’ lambdaapp
  | lambdaapp ‘<’ lambdaapp
  | lambdaapp ‘<=’ lambdaapp
  | lambdaapp ‘>’ lambdaapp
  | lambdaapp ‘>=’ lambdaapp
  | lambdaapp ‘=’ lambdaapp
  | lambdaapp ‘!=’ lambdaapp
  | ‘{‘ conditions ’}’
  | ‘-’ lambdaapp
conditions ::= lambda ‘WHEN’ lambda ‘,’ conditions
  | lambda ‘OTHERWISE’
aexp ::= real
  | integer
  | string
  | ‘#t’
  | ‘#f’
  | ‘(‘ lambda ’)’
  | id
  | ‘(‘ ‘FN’ ‘(‘ idlist ’)’ ‘=’ lambda ’)’
  | ‘(‘ ‘RFUN’ id ‘(‘ idlist ’)’ ‘=’ lambda ’)’
  | ‘LET’ vals ‘IN’ lambda ‘END’
  | ‘RLET’ vals ‘IN’ lambda ‘END’
  | ‘[‘ lambdalist ’]’
  | ‘[‘ lambda ’]’
  | ‘[‘ ’]’
vals ::= {value}
value ::= ‘VAL’ id ‘=’ lambda
idlist ::= id {‘,’ id}
```

What is claimed is:

1. A method for producing an electronic device configuration, comprising the steps of:
forming a program code data file in which a dynamical system model is encoded in an iterative modeling programming language, wherein a state of the dynamical system model on each iteration is encoded in a state primitive of the modeling language;
inputting program code data from the program code data file into a computer system programmed with a compiler system corresponding to the modeling programming language and programmed with a system generator;
operating the computer system under control of the compiler system to compile the program code data into directed flow graph data representing the dynamical system, wherein states of the dynamical system define roots of directed flow graphs; and
operating the computer system under control of the system generator to transform the directed flow graph data into device configuration data stored in an output data file, the device configuration data representing an electronic device configuration including an execution engine modeling the dynamical system, whereby the electronic device is configurable from the configuration data.

2. The method claimed in claim 1, wherein the step of forming a program code data file comprises encoding a system of one or more difference equations to model the dynamical system, wherein each difference equation is encoded in a difference equation primitive of the modeling programming language.

3. The method claimed in claim 2, wherein the difference equations comprise differential equations.

4. The method claimed in claim 1, wherein the step of operating the computer system under control of the compiler system to compile the program code data file into directed flow graph data comprises:
compiling the program code data file into an intermediate representation; and
transforming the intermediate representation into the directed flow graph data.

5. The method claimed in claim 4, wherein the intermediate representation comprises lambda calculus data.

6. The method claimed in claim 1, wherein the step of operating the computer system under control of the system generator to transform the directed flow graph data into device configuration data comprises:
scheduling device resource usage by populating a data structure relating device resources to time intervals; and
transforming the populated data structure into hardware description data.

7. The method claimed in claim 6, wherein the step of populating a data structure comprises populating the data structure in response to a multi-metric cost analysis.

8. The method claimed in claim 7, wherein the step of populating a data structure in response to a multi-metric cost analysis comprises:
determining one or more candidate device resources to associate with nodes of the directed flow graph;
computing a cost for each combination of a node, candidate device resource, and time interval in response to a plurality of metrics; and
associating each node with a resource and a time interval in response to computed costs.

9. The method claimed in claim 8, wherein the step of computing a cost is performed in response to one or more metric criteria selected from the group: whether a resource has already been associated with a node and time interval; ratio of resources that have already been associated with a node and time interval to resources that have not yet been associated with a node and time interval; results of comparisons of topologies between a plurality of directed flow graphs; compatible bit-widths; decimal point alignment; latency; successor nodes; and predecessor nodes.

10. The method claimed in claim 9, wherein the step of computing a cost further comprises weighting the selected metric criteria with respect to one another.

11. A computer program product for producing an electronic device configuration, the computer program product comprising a computer-readable medium encoded with instructions which, when performed by a computer, are capable of causing the computer to:
receive as input a program code data file in which a dynamical system model is encoded in an iterative modeling programming language, wherein a state of the dynamical system model on each iteration is encoded in a state primitive of the modeling language;
compile the program code data into directed flow graph data representing the dynamical system, wherein states of the dynamical system define roots of directed flow graphs; and
transform the directed flow graph data into device configuration data stored in an output data file, the device configuration data representing an electronic device configuration including an execution engine modeling the dynamical system, whereby the electronic device is configurable from the configuration data.

12. The computer program product claimed in claim 11, wherein the program code data file comprises a system of one or more difference equations encoded in a modeling programming language to model the dynamical system, wherein each difference equation is encoded in a difference equation primitive of the modeling programming language.

13. The computer program product claimed in claim 12, wherein the difference equations comprise differential equations.

14. The computer program product claimed in claim 11, wherein the instructions capable of causing the computer to compile the program code data file are capable of causing the computer to:
compile the program code data file into an intermediate representation; and
transform the intermediate representation into the directed flow graph data.

15. The computer program product claimed in claim 14, wherein the intermediate representation comprises lambda calculus data.

16. The computer program product claimed in claim 11, wherein the instructions capable of causing the computer to transform the directed flow graph data into device configuration data are capable of causing the computer to:
schedule device resource usage by populating a data structure relating device resources to time intervals; and
transform the populated data structure into hardware description data.

17. The computer program product claimed in claim 16, wherein instructions capable of causing the computer to populate a data structure are capable of causing the computer to populate the data structure in response to a multi-metric cost analysis.

18. The computer program product claimed in claim 17, wherein instructions capable of causing the computer to populate a data structure in response to a multi-metric cost analysis are capable of causing the computer to:
determine one or more candidate device resources to associate with nodes of the directed flow graph;
compute a cost for each combination of a node, candidate device resource, and time interval in response to a plurality of metrics; and
associate each node with a resource and a time interval in response to computed costs.

19. The computer program product claimed in claim 18, wherein the instructions capable of causing the computer to compute a cost operate upon one or more metric criteria selected from the group: whether a resource has already been associated with a node and time interval; ratio of resources that have already been associated with a node and time interval to resources that have not yet been associated with a node and time interval; results of comparisons of topologies between a plurality of directed flow graphs; compatible bit-widths; decimal point alignment; latency; successor nodes; and predecessor nodes.

20. The computer program product claimed in claim 19, wherein the instructions capable of causing the computer to compute a cost further comprise instructions capable of causing the computer to weight the selected metric criteria with respect to one another.
